(19) United States
(12) Patent Application Publication
(10) Pub. No.: US 2015/0323089 A1
(43) Pub. Date: Nov. 12, 2015

(54) Fire Equipment Control Valve Structure

(71) Applicant: Wenchang Wang, Tainan City (TW)

(72) Inventor: Wenchang Wang, Tainan City (TW)

(21) Appl. No.: 14/273,660

(22) Filed: May 9, 2014

(51) Int. Cl. F16K 27/12; F16K 51/00

(52) U.S. Cl. CPC F16K 27/12; F16K 51/00

(57) ABSTRACT

A fire equipment control valve structure includes a tube cap installed at an output end of a control valve, and the tube cap is formed by a connecting end and a collecting end. The connecting end is sheathed on the output end of the control valve, and the collecting end has a hollow chamber coupled to a cover and provided for collecting and storing a flow valve to prevent missing, losing or forgetting the flow valve, so as to provide a convenient use.

### BACKGROUND OF THE INVENTION

1. Field of the Invention

The present invention relates to a fire equipment control valve structure, and more particularly to the structure capable of preventing a flow control valve from missing and providing a convenient use.

2. Description of the Related Art

In general, a fire equipment control valve is installed at a water tank of a fire engine for supplying water or foam (or a mixture of firefighting chemicals and water), and the control valve includes a plurality of flow valves installed at an output end for controlling and adjusting the output quantity of water or foam.

However, the conventional flow valves and control valves are stored separately, or the flow valves are collected and stored in a bag, and tied onto the control valve by a string. Therefore, the flow valves are missed or lost very often, or users forget to bring them for use. Obviously, the conventional flow valves require further improvements. In view of the foregoing drawbacks of the prior art, the inventor or the present invention designed and developed a fire equipment control valve in accordance with the present invention to overcome the drawbacks of the prior art.

### SUMMARY OF THE INVENTION

Therefore, it is a primary objective of the present invention to provide a fire equipment control valve structure having a control valve with a tube cap for collecting and storing a flow valve, so as to prevent missing or losing the flow valve, so as to achieve the effect of providing a convenient use.

To achieve the aforementioned object, the present invention provides a fire equipment control valve structure comprising a tube cap installed at an output end of a control valve, and the tube cap is comprised of a connecting end and a collecting end, wherein the connecting end is sheathed on the output end of the control valve, and the collecting end has a hollow chamber coupled to a cover and provided for collecting and storing a flow valve to prevent missing or losing the flow valve, so as to provide a convenient use.

### BRIEF DESCRIPTION OF THE DRAWINGS

FIG. 1 is an exploded view of the present invention;

FIG. 2 is an exploded view of a tube cap of the present invention;

FIG. 3 is a perspective view of the present invention.

FIG. 4 is a cross-sectional view of a tube cap of the present invention; and

FIG. 5 is a perspective view of another embodiment of the present invention.

### DETAILED DESCRIPTION OF THE PREFERRED EMBODIMENTS

The technical characteristics, contents, advantages and effects of the present invention will be apparent with the detailed description of two preferred embodiments accompanied with related drawings as follows.

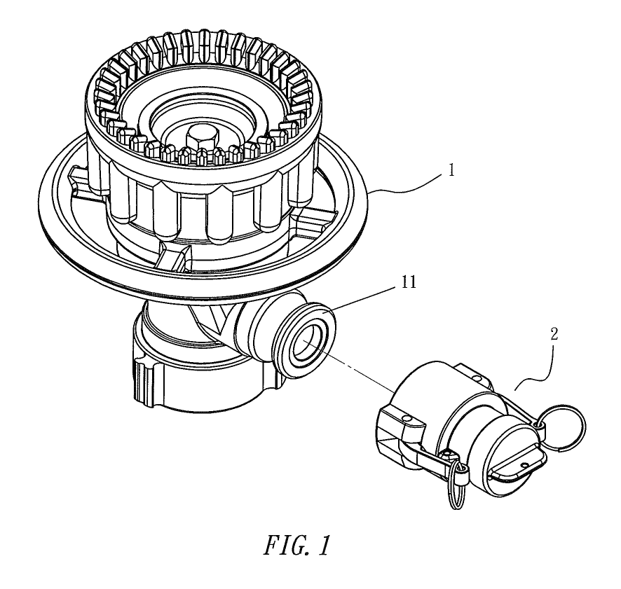

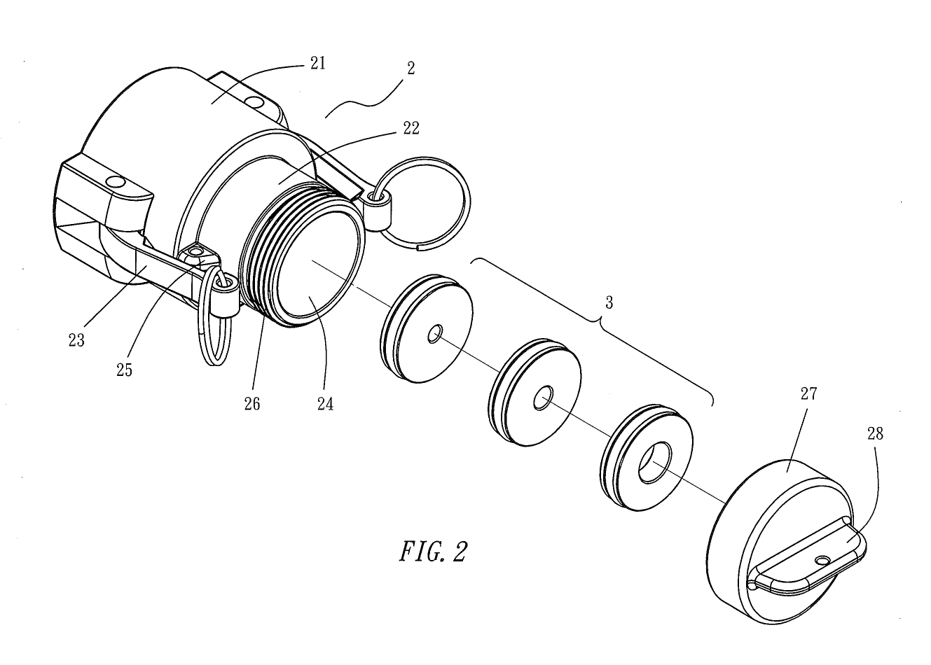

With reference to FIGS. 1 to 4, a fire equipment control valve structure of the present invention comprises a tube cap 2 installed at an output end 11 of a control valve 1, and the tube cap 2 is integrally foamed by a connecting end 21 and a collecting end 22, wherein the connecting end 21 has a relatively larger diameter, so that the connecting end 21 can be sheathed on the output end 11 of the control valve 1, and both external sides of the connecting end 21 have an eccentric press buckle 23 each, so that the tube cap 2 can be connected to the output end 11 of the control valve 1, and the collecting end 22 has a relatively smaller diameter and includes a hollow chamber 24 for collecting and storing a flow valve 3, and an external side of the collecting end 22 (or an external side of the hollow chamber 24) has an ear 25 and an external thread 26, and the external thread 26 (outside the chamber 24) is provided for screwing and connecting a cover 27 to seal the hollow chamber 24, and the top of the cover 27 further includes a lug 28.

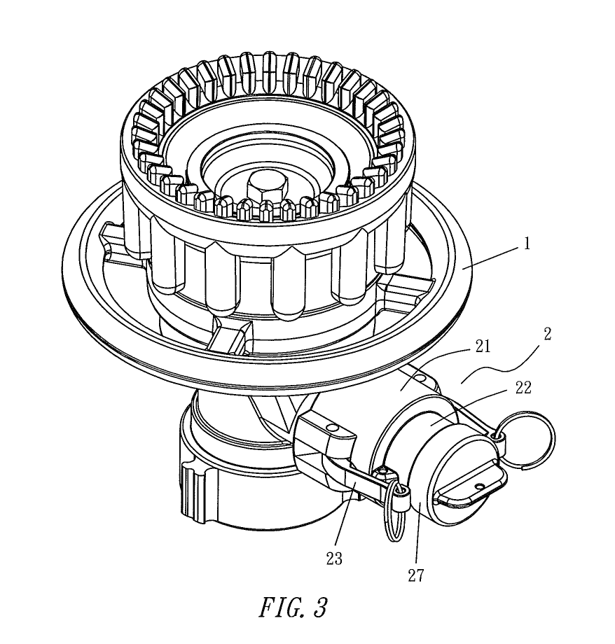

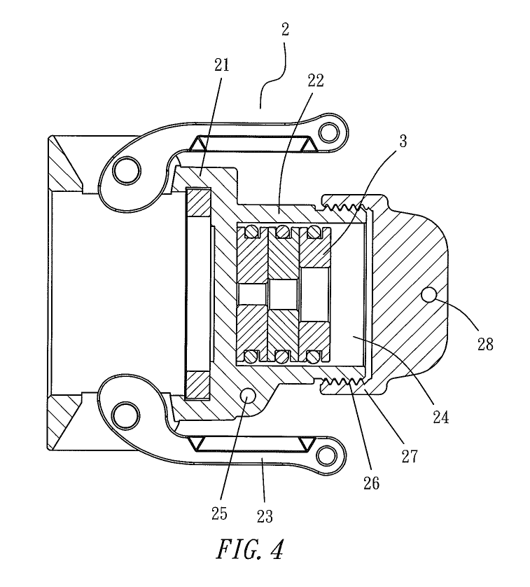

Based on the aforementioned structure, the present invention sheathes the tube cap 2 on the output end 11 of the control valve 1 by the connecting end 21, and the two eccentric press buckles 23 are used for buckling the tube cap 2 and the control valve 1 with each other, and then the flow valve 3 is put into the chamber 24 at the collecting end of the tube cap, and the cover 24 and the collecting end 22 are screwed and coupled to each other to seal the chamber 24, and collect and store the flow valve 3 as shown in FIGS. 3 and 4, so as to prevent missing, losing, or forgetting the flow valve 3.

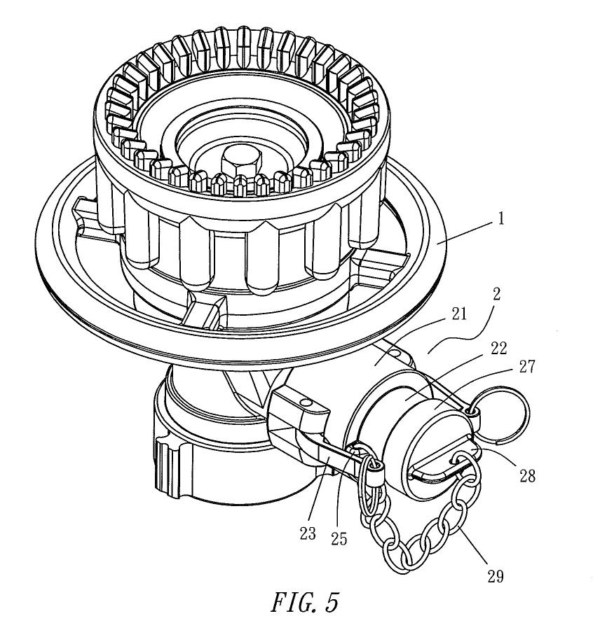

When the tube cap 2 and the control valve 1 are buckled together, and the flow valve 3 is collected and stored in the tube cap 2 (or the chamber 24), the present invention further uses a connector such as a chain 29 or a string to connect the ear 26 and the lug 28 in order to connect the cover 27 and the tube cap 2 with each other as shown in FIG. 5 and prevent missing the cover 27. This is another embodiment of the present invention.

In summation of the description above, the present invention has the following advantages and effects over the prior art.
1. When the control valve 1 is not in use, the tube cap 2 can be buckled with the control valve 1 quickly and securely.
2. The tube cap 2 can be used for collecting and storing the flow valve 3, and the cover 27 is screwed, connected and sealed, and thus integrated with the control valve 1 as a whole. Such arrangement not just provides a convenient use only, but also prevents missing or losing the flow valve 3.
3. The tube cap 2 and the cover 27 can be connected with each other to prevent missing or losing the cover 27.

In summation of the description above, the present invention complies with the patent application requirements, and thus is duly filed for patent application. While the invention has been described by means of specific embodiments, numerous modifications and variations could be made thereto by those skilled in the art without departing from the scope and spirit of the invention set forth in the claims.

What is claimed is:

1. A fire equipment control valve structure, comprising a tube cap installed at an output end of a control valve, and the tube cap being comprised of a connecting end and a collecting end, wherein the connecting end is sheathed on the output end of the control valve, and the collecting end has a hollow chamber coupled to a cover and provided for collecting and storing a flow valve to prevent missing, losing or forgetting the flow valve, so as to provide a convenient use.
